(19) United States
(12) Patent Application Publication
(10) Pub. No.: US 2023/0099796 A1
(43) Pub. Date: Mar. 30, 2023

(54) GENERATOR

(71) Applicant: HONDA MOTOR CO., LTD., Tokyo (JP)

(72) Inventor: Haruka Nishii, Wako-shi (JP)

(21) Appl. No.: 17/944,297

(22) Filed: Sep. 14, 2022

(30) Foreign Application Priority Data
Sep. 29, 2021 (JP) 2021-159260

(51) Int. Cl. F02B 63/04; F02B 77/13

(52) U.S. Cl. CPC F02B 63/044; F02B 77/13; F02B 2063/045

(57) ABSTRACT

An outer casing includes an under panel disposed on a bottom surface, and the under panel integrally includes a reinforcing part that supports an engine. By the reinforcing part, strength and rigidity can be secured without using other parts, a height dimension of the reinforcing part can be suppressed to be low compared to the case of separately providing a support member as in the conventional art, and a generator can be made light in weight and miniaturized. In addition, since a structure is such that the engine is supported by one under panel, need of fastening the other parts is eliminated, there is no risk of generating a gap between the parts, and noise can be reduced.

### INCORPORATION BY REFERENCE

The present application claims priority under 35 U.S.C. § 119 to Japanese Patent Application No. 2021-159260 filed on Sep. 29, 2021. The content of the application is incorporated herein by reference in its entirety.

### BACKGROUND OF THE INVENTION

### Field of the Invention

The present invention relates to a generator.

### Description of the Related Art

Conventionally, a technology of forming an intake port in communication with outside in a front sidewall and a right sidewall for a planar under frame, making a rear sidewall attachable and detachable, laying a pair of front and rear support members that are long in a left-right direction inside in parallel to each other, and fixing an engine to the support members through a vibration-proof mount member has been disclosed (for example, see Japanese Patent Laid-Open No. 2003-074362).

However, in the conventional technology, since a structure is such that an engine is supported by a planar under frame, it is needed to secure strength and rigidity of the under frame. Accordingly, it has been managed by fixing support members to the under frame by welding or fastening with a bolt or the like.

When the under frame is configured in such a manner, there are problems that the number of components increases and weight increases. Further, since the support members are separately fixed, a height dimension when the engine is supported increases and it is a problem that a generator cannot be miniaturized. In addition, since a gap is generated between parts when fastening a plurality of parts, it is a problem that noise cannot be reduced.

The present invention is implemented in consideration of circumstances described above, and it is an object to provide a generator for which strength and rigidity can be secured without increasing a height dimension of an under panel and miniaturization and noise reduction can be achieved.

### SUMMARY OF THE INVENTION

In order to achieve the object, for a generator according to a present invention aspect, in the generator for which at least a fuel tank, an engine and an alternator are disposed inside an outer casing, the outer casing includes an under panel disposed on a bottom surface and the under panel integrally includes a reinforcing part that supports the engine.

According to the present invention aspect, by the reinforcing part, strength and rigidity can be secured without using other parts, a height dimension of the reinforcing part can be suppressed to be low compared to a case of separately providing a support member as in the conventional art, and the generator can be made light in weight and be miniaturized. In addition, since the structure is such that the engine is supported by one under panel, need of fastening the other parts is eliminated, there is no risk of generating a gap between the parts, and noise can be reduced.

### BRIEF DESCRIPTION OF THE DRAWINGS

FIG. 1 is a configuration view of a generator 1 according to the present invention;

FIG. 2 is a perspective view illustrating an under panel of the generator in the present embodiment;

FIG. 3 is a side view illustrating the under panel in the present embodiment;

FIG. 4 is a plan view illustrating a state where an engine is loaded on the under panel in the present embodiment;

FIG. 5 is a side view illustrating the state where the engine is loaded on the under panel in the present embodiment; and

FIG. 6 is a side view of a part illustrating the state where a fan cover is loaded on the under panel through a mount member in the present embodiment.

### DETAILED DESCRIPTION OF THE PREFERRED EMBODIMENT

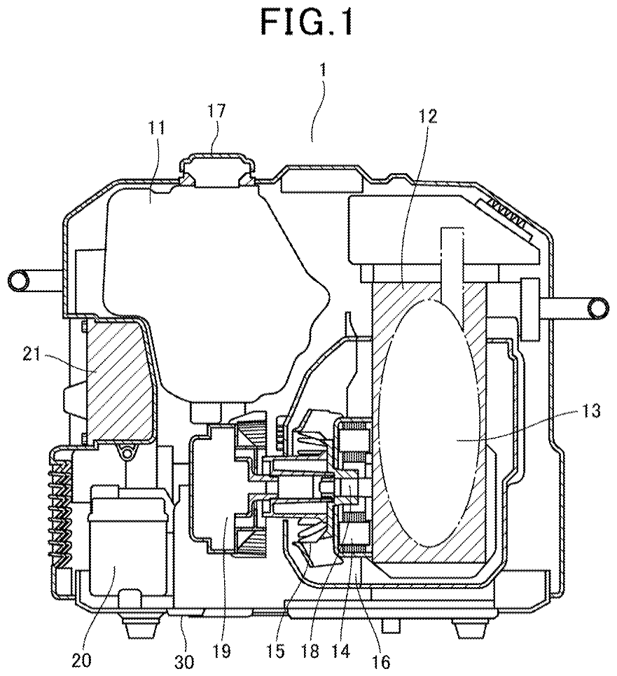

FIG. 1 is a configuration view of a generator 1.

The generator 1 includes an outer casing 10. Inside the outer casing 10, a fuel tank 11, an engine 12, a muffler 13, an alternator 14, a fan 15, and a shroud 16 are disposed.

The fuel tank 11 includes a fuel inlet that can be accessed from an outside, and fuel can be put into the fuel tank 11 through the fuel inlet. A fuel inlet cap 17 is removably mounted on the fuel inlet.

The engine 12 is an ignition air-cooled engine driven by the fuel inside the fuel tank 11. The engine 12 includes a cylinder, a piston that reciprocates inside the cylinder, and a crankshaft 18 that is coupled to the piston through a connecting rod.

An intake pipe connected to the engine 12 is provided with a throttle valve and a fuel supply device. Air of which the volume is adjusted by the throttle valve and fuel supplied from the fuel supply device are mixed, and this air-fuel mixture is supplied to the engine 12. The engine 12 combusts the air-fuel mixture in a combustion chamber to drive the piston and thereby rotates the crankshaft 18 through the connecting rod.

The muffler 13 is connected to an outlet of an exhaust pipe connected to the engine 12. The muffler 13 serves purposes such as reducing the exhaust sound level.

The fuel to drive the engine 12 may be gasoline or may be a liquid fuel other than gasoline. The fuel supply device may have a configuration using an injector or a configuration using a carburetor.

The generator 1 includes a control unit. The control unit has a processor, such as a central processing unit (CPU), and a memory, such as a read-only memory (ROM). The control unit controls parts of the generator 1 as the processor executes a program stored in the memory. The control unit functions as, for example, an electronic control unit (ECU) that outputs control signals for controlling the output of the engine 12.

The alternator 14 is mounted to the crankshaft 18 of the engine 12. The alternator 14 is a multipolar alternator that is driven by the engine 12 to generate alternating-current electricity. The alternator 14 has a rotor that rotates integrally with the crankshaft 18, and a stator that is disposed concentrically with the rotor so as to face a circumferential surface of the rotor.

The rotor is provided with a permanent magnet. The stator is provided with U-phase, V-phase, and W-phase windings that are disposed at a phase angle of, for example, 120 degrees to one another.

The fan 15 is mounted on the crankshaft 18. On the crankshaft 18, a starting device 19 for starting the engine 12 is disposed. When the engine 12 is driven, electricity is generated by the alternator 14. When the engine 12 is driven, the fan 15 rotates, sending cooling air to the engine 12. The alternator 14 generates alternating-current electricity.

The shroud 16 includes an opening used for ventilation for taking in air. The shroud 16 covers the alternator 14 and the fan 15 and thereby guides the air sent by the fan 15 to the periphery of the engine 12.

The outer casing 10 includes an intake port through which outside air is taken in and an exhaust port through which air having cooled the engine 12 is discharged.

The generator 1 includes an inverter 20. The inverter 20 controls the voltage and the frequency of the alternating-current electricity generated by the alternator 14 so as to stabilize the output.

The generator 1 further includes a control panel 21. The control panel 21 is provided with an electrical outlet, an operating switch, and others.

The electrical outlet is supplied with alternating-current electricity from the inverter 20. A plug of a device that uses generated electricity is connected to the electrical outlet. Alternatively, the electrical outlet may be supplied with direct-current electricity.

Next, a frame structure of the generator will be explained.

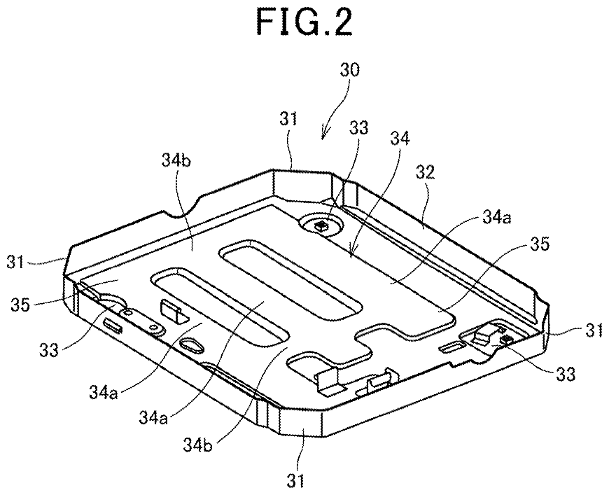

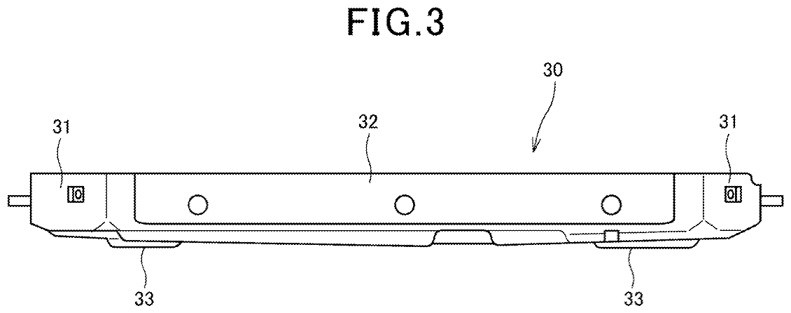

FIG. 2 is a perspective view illustrating an under panel 30 of the generator 1 in the present embodiment. FIG. 3 is a side view illustrating the under panel 30 in the present embodiment.

As illustrated in FIG. 2, the outer casing 10 includes the under panel 30 configuring a lower surface.

The under panel 30 is formed roughly in a rectangular shape, and a chamfered part 31 formed by being notched at roughly 45° is formed at four corners of the under panel 30. At an outer peripheral edge of a main body of the under panel 30, a flange part 32 erected upwards is formed.

At four corners of a lower surface of the under panel 30, a projected part 33 for a leg slightly swollen downwards is formed. On the under panel 30, a reinforcing part 34 slightly swollen upwards roughly in a grid shape is formed.

The reinforcing part 34 is integrally formed by drawing. Note that, on the under panel 30, only a fixing hole 35 needed for fixing the engine 12 and the leg or the like is formed and a ventilation hole is not formed.

The reinforcing part 34 includes three vertical reinforcing parts 34a extending in a front-back direction of the under panel 30 and two horizontal reinforcing parts 34b roughly orthogonally crossing the vertical reinforcing parts 34a and extending in a width direction of the under panel 30.

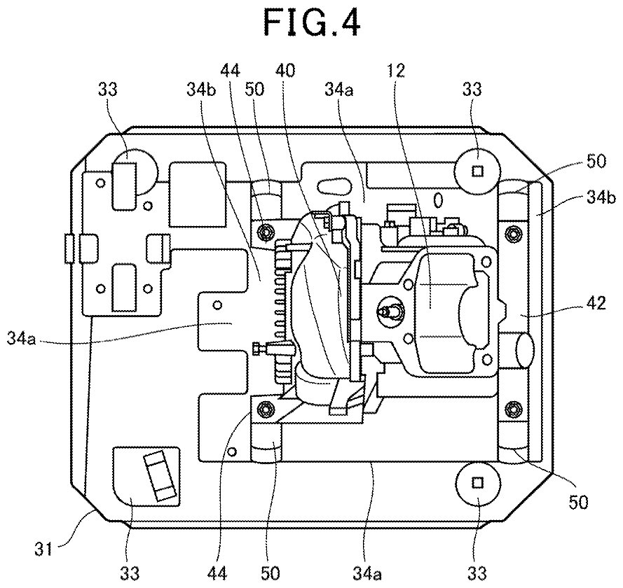

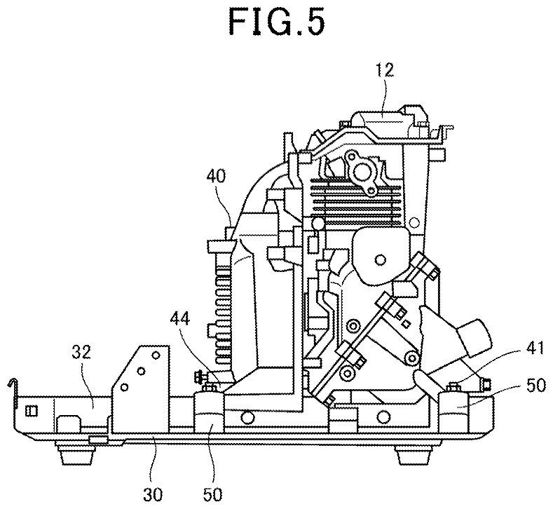

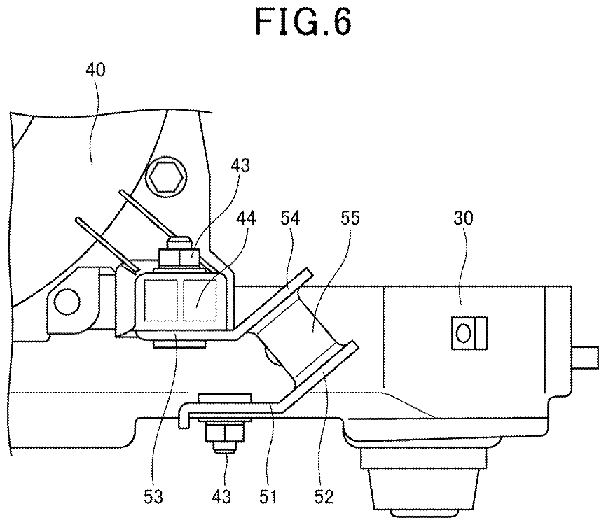

FIG. 4 is a plan view illustrating a state where the engine 12 is loaded on the under panel 30 in the present embodiment. FIG. 5 is a side view illustrating the state where the engine is loaded on the under panel 30 in the present embodiment. FIG. 6 is a side view of a part illustrating the state where a fan cover 40 is loaded on the under panel 30 through a mount member 50 in the present embodiment.

As illustrated in FIG. 4 and FIG. 5, on an upper surface of the reinforcing part 34, the engine 12 and the fan cover 40 fixed integrally with the engine 12 are mounted.

Specifically, on a rear side lower part of the engine 12, a pair of left and right engine mount parts 41 are provided. On the lower surface of the engine mount parts 41, a fixing bracket 42 extending in the width direction of the under panel 30 is fixed with a bolt 43.

On both sides of the lower part of the fan cover 40, a pair of left and right fan cover mount parts 44 are provided.

For the engine 12, the fixing bracket 42 is installed on the horizontal reinforcing part 34b on a rear side, and the fan cover mount parts 44 are installed at an intersection part of the horizontal reinforcing part 34b on a front side and the vertical reinforcing parts 34a positioned on both sides.

In the state, the engine 12 and the fan cover 40 are fixed to the under panel 30 through the mount member 50.

The mount member 50 includes, as illustrated in FIG. 6, a lower plate part 51 to be brought into contact with the upper surface of the under panel 30, a lower inclined part 52 inclined obliquely upwards and extending from one side edge of the lower plate part 51, an upper plate part 53 to be brought into contact with the lower surface of the fixing bracket 42 mounted to the engine 12 or the fan cover mount parts 44, an upper inclined part 54 inclined obliquely upwards and extending from one side edge of the upper plate part 53, and a coupling part 55 that couples the lower inclined part 52 and the upper inclined part 54.

Next, a procedure of fixing the engine 12 and the fan cover 40 to the under panel 30 will be explained.

First, the lower plate part 51 of the mount member 50 is tightened and fixed to the reinforcing part 34 of the under panel 30 with a bolt passing through the under panel 30 and a nut.

Then, the fixing bracket 42 mounted to the engine 12 or the fan cover mount parts 44 are tightened and fixed to the upper plate part 53 of the mount member 50 with a bolt.

Thus, the engine 12 and the fan cover 40 can be fixed to the under panel 30.

In the present embodiment, the reinforcing part 34 and the projected part 33 for the leg are integrally formed in a drawn state so that a height dimension from the lower surface of the projected part 33 for the leg to the upper surface of the reinforcing part 34 can be formed to be short compared to the case of mounting a separate support member for mounting the engine to the upper surface of the under panel 30 as in the conventional prior art.

In addition, by forming the reinforcing part 34 in the drawn state, a slope is formed at a part other than the part to fix the engine 12 and the fan cover 40, and thus strength and rigidity can be increased.

Further, since the reinforcing part 34 is formed in a wide range of the under panel 30, the strength and the rigidity can be secured.

As described above, in the present embodiment, the outer casing 10 includes the under panel 30 disposed on a bottom surface and the under panel 30 integrally includes the reinforcing part 34 that supports the engine 12.

Thus, by the reinforcing part 34, the strength and the rigidity can be secured without using other parts. As a result, the height dimension of the reinforcing part 34 can be suppressed to be low compared to the case of separately providing a support member as in the conventional art, and the generator can be made light in weight and miniaturized. In addition, since a structure is such that the engine 12 is supported by one under panel 30, need of fastening the other parts is eliminated, there is no risk of generating a gap between the parts, and the noise can be reduced.

Further, in the present embodiment, the reinforcing part 34 is formed in the drawn state of being slightly swollen to an upper surface side of the under panel 30.

Thus, by forming the reinforcing part 34 in the drawn state, the strength and the rigidity can be secured by one under panel 30 without using the other parts.

In addition, in the present embodiment, the under panel 30 integrally includes the projected part 33 for the leg that is slightly swollen to a lower surface side of the under panel 30 and supports the leg.

Thus, by also providing the projected part 33 for the leg integrally with the under panel 30, the height dimension of the under panel 30 can be suppressed to be low even together with the height dimension of the projected part 33 for the leg and the height dimension of the reinforcing part 34, the height dimension of the generator can be suppressed and miniaturization can be achieved.

Further, in the present embodiment, the engine 12 is fixed to the reinforcing part 34 of the under panel 30 through the mount member 50.

Thus, the engine 12 can be fixed in the state of being separated from the under panel 30.

Note that, while the present invention has been explained in the embodiment, the present invention is not limited to the embodiment described above and various modifications, substitutions, addition and omission or the like are possible as needed.

[Configurations Supported by Embodiment Described Above]

The embodiment described above supports the following configurations.

(Configuration 1)

A generator for which at least a fuel tank, an engine and an alternator are disposed inside an outer casing, wherein the outer casing includes an under panel disposed on a bottom surface, and the under panel integrally includes a reinforcing part that supports the engine.

According to the configuration, by the reinforcing part, the strength and the rigidity can be secured without using other parts. As a result, the height dimension of the reinforcing part can be suppressed to be low compared to the case of separately providing a support member as in the conventional art, and the generator can be made light in weight and miniaturized. In addition, since the structure is such that the engine is supported by one under panel, need of fastening the other parts is eliminated, there is no risk of generating a gap between the parts, and the noise can be reduced.

(Configuration 2)

The generator according to configuration 1, wherein the reinforcing part is formed in a drawn state of being slightly swollen to an upper surface side of the under panel.

According to the configuration, by also providing the projected part for the leg integrally with the under panel, the height dimension of the under panel can be suppressed to be low even together with the height dimension of the projected part for the leg and the height dimension of the reinforcing part, the height dimension of the generator can be suppressed and miniaturization can be achieved.

(Configuration 3)

The generator according to configuration 1 or configuration 2, wherein the under panel integrally includes a projection part for a leg, that is slightly swollen to a lower surface side of the under panel and supports the leg.

According to the configuration, by also providing the projected part for the leg integrally with the under panel, the height dimension of the under panel can be suppressed to be low even together with the height dimension of the projected part for the leg and the height dimension of the reinforcing part, the height dimension of the generator can be suppressed and miniaturization can be achieved.

(Configuration 4)

The generator according to any one of configurations 1 to 3, wherein the engine is fixed to the reinforcing part of the under panel through a mount member.

According to the configuration, the engine can be fixed in the state of being separated from the under panel.

### REFERENCE SIGNS LIST

1 generator

10 outer casing

11 fuel tank

12 engine

30 under panel

31 chamfered part

32 flange part

33 projected part for leg

34 reinforcing part

34a vertical reinforcing part

34b horizontal reinforcing part

35 fixing hole

40 fan cover

41 engine mount part

42 fixing bracket

43 bolt

44 fan cover mount part

50 mount member

51 lower plate part

52 lower inclined part

53 upper plate part

54 upper inclined part

55 coupling part

What is claimed is:

1. A generator for which at least a fuel tank, an engine and an alternator are disposed inside an outer casing, wherein
the outer casing includes an under panel disposed on a bottom surface, and
the under panel integrally includes a reinforcing part that supports the engine.

2. The generator according to claim 1, wherein the reinforcing part is formed in a drawn state of being slightly swollen to an upper surface side of the under panel.

3. The generator according to claim 1, wherein the under panel integrally includes a projection part for a leg, that is slightly swollen to a lower surface side of the under panel and supports the leg.

4. The generator according to claim 1, wherein the engine is fixed to the reinforcing part of the under panel through a mount member.
